(19) United States
(12) Patent Application Publication
(10) Pub. No.: US 2024/0411013 A1
(43) Pub. Date: Dec. 12, 2024

(54) INFORMATION PROVIDING DEVICE, INFORMATION PROVIDING METHOD, RECORDING MEDIUM, AND OBSERVATION SYSTEM

(71) Applicant: NEC Corporation, Minato-ku, Tokyo (JP)

(72) Inventors: Nana JUMONJI, Tokyo (JP); Takakazu IshII, Tokyo (JP); Hiromichi Hirata, Tokyo (JP); Shouhei Ohno, Tokyo (JP)

(73) Assignee: NEC Corporation, Minato-ku, Tokyo (JP)

(21) Appl. No.: 18/688,853

(22) PCT Filed: Sep. 21, 2021
(86) PCT No.: PCT/JP2021/034495

§ 371 Date: Mar. 4, 2024

(51) Int. Cl. G01S 13/90

(52) U.S. Cl. CPC G01S 13/9027; G01S 13/9023

(57) ABSTRACT

An acquiring unit acquires measured data of an amount of displacement of a ground surface, measured on the basis of observation data obtained by SAR, and acquires information indicating a characteristic of the ground surface at the location at which the amount of displacement of the ground surface was measured, a classifying unit classifies the characteristic of the ground surface at the location at which the amount of displacement of the ground surface was measured, on the basis of the information indicating the characteristic of the ground surface, and a display unit displays a symbol indicating the classification of the characteristic of the ground surface, linked to the measured data of the amount of displacement of the ground surface, together with map data.

### TECHNICAL FIELD

The present invention relates to an information providing device, an information providing method, a recording medium, and an observation system, and for example, relates to an information providing device that provides map information based on synthetic aperture radar (SAR) observation data, an information providing method, a recording medium, and an observation system.

### BACKGROUND ART

Synthetic aperture radar (SAR) is mounted on an aircraft or an artificial satellite, and observes a distance from the earth's surface to an SAR-equipped vehicle using microwaves. A technology called interferometric SAR (InSAR) enables measurement of displacement of the earth's surface in a vertical direction (such as uplift/sinking) with accuracy at the centimeter level from two pieces of SAR observation data (for example, PTL 1). In addition, in recent years, there is also a technology of measuring displacement of the earth's surface with accuracy at the millimeter level from pieces of observation data collected over more periods (about 20 times or more) (for example, PTL 2). The earth's surface herein includes not only the ground surface but also an artificial object such as a pavement or a building. The SAR observation data is widely used not only by researchers of national government and geology, but also in various industries. For example, an interferometric SAR image in which a displacement amount of the earth's surface in a region observed by the SAR is expressed (data visualization) by a color element (hue or brightness) is often used to investigate a situation of earth's surface subsidence and to monitor diastrophism associated with an earthquake. In addition, SAR observation data may be used for planning of construction and repair of an infrastructure building.

### CITATION LIST

### Patent Literature

PTL 1: JP 2017-215248 A
PTL 2: U.S. Pat. No. 6,583,751

### SUMMARY OF INVENTION

### Technical Problem

The displacement of the earth's surface includes displacement caused by natural factors such as temperature, humidity, and precipitation, and displacement caused by artificial factors such as construction and traffic. In a related technology, since only measurement data of the displacement amount of the earth's surface is provided, it is difficult for a user of the SAR observation data to determine whether the displacement of the earth's surface is based on some abnormality or not.

The present invention has been made in view of the above problems, and an object of the present invention is to provide information regarding displacement of the earth's surface to a user of SAR observation data.

### Solution to Problem

An information providing device according to an aspect of the present invention includes: acquisition means that acquires measurement data of a displacement amount of an earth's surface measured based on synthetic aperture radar (SAR) observation data, and acquires information indicating a feature of the earth's surface at a point where the displacement amount of the earth's surface is measured: classification means that classifies the feature of the earth's surface at the point where the displacement amount of the earth's surface is measured based on the information indicating the feature of the earth's surface; and display means that displays a symbol representing a classification of the feature of the earth's surface linked to the measurement data of the displacement amount of the earth's surface together with map data.

An information providing method according to an aspect of the present invention includes: acquiring measurement data of a displacement amount of an earth's surface measured based on SAR observation data, and acquiring information indicating a feature of the earth's surface at a point where the displacement amount of the earth's surface is measured: classifying the feature of the earth's surface at the point where the displacement amount of the earth's surface is measured based on the information indicating the feature of the earth's surface; and displaying a symbol representing a classification of the feature of the earth's surface linked to the measurement data of the displacement amount of the earth's surface together with map data.

A recording medium according to an aspect of the present invention records a program for causing a computer to execute: acquiring measurement data of a displacement amount of an earth's surface measured based on SAR observation data, and acquiring information indicating a feature of the earth's surface at a point where the displacement amount of the earth's surface is measured: classifying the feature of the earth's surface at the point where the displacement amount of the earth's surface is measured based on the information indicating the feature of the earth's surface; and displaying a symbol representing a classification of the feature of the earth's surface linked to the measurement data of the displacement amount of the earth's surface together with map data.

An observation system according to an aspect of the present invention includes: the information providing device; a database that stores the SAR observation data: a display that displays the symbol representing the classification of the feature of the earth's surface linked to the measurement data of the displacement amount of the earth's surface together with the map data.

### Advantageous Effects of Invention

According to one aspect of the present invention, it is possible to provide information regarding displacement of the earth's surface to a user of SAR observation data.

### BRIEF DESCRIPTION OF DRAWINGS

FIG. 1 is a diagram schematically illustrating an example of a configuration of an observation system to which an information providing device according to any one of first to fifth example embodiments is applicable.

FIG. 2 is a block diagram illustrating a configuration of the information providing device according to the first example embodiment.

FIG. 3 is a flowchart illustrating an example of an operation of the information providing device according to the first example embodiment.

FIG. 4 is a view illustrating an example of a screen displayed on a display by the information providing device according to the second example embodiment.

FIG. 5 is a view illustrating another example of the screen displayed on the display by the information providing device according to the second example embodiment.

FIG. 6 is a view illustrating still another example of the screen displayed on the display by the information providing device according to the second example embodiment.

FIG. 7 is a block diagram illustrating a configuration of the information providing device according to the third example embodiment.

FIG. 8 is a flowchart illustrating an example of an operation of the information providing device according to the third example embodiment.

FIG. 9 is a view illustrating an example of a screen displayed on a display by the information providing device according to the third example embodiment.

FIG. 10 is a view illustrating another example of the screen displayed on the display by the information providing device according to the third example embodiment.

FIG. 11 is a view illustrating still another example of the screen displayed on the display by the information providing device according to the third example embodiment.

FIG. 12 is a view illustrating an example of a screen displayed on the display by the information providing device according to a modification of the third example embodiment.

FIG. 13 is a block diagram illustrating a configuration of the information providing device according to the fourth example embodiment.

FIG. 14 is a view illustrating an example of a screen displayed on a display by the information providing device according to the fourth example embodiment.

FIG. 15 is a view illustrating another example of the screen displayed on the display by the information providing device according to the fourth example embodiment.

FIG. 16 is a block diagram illustrating a configuration of the information providing device according to the fifth example embodiment.

FIG. 17 is a diagram illustrating an example of a hardware configuration of the information providing device according to any one of the first to fifth example embodiments.

### EXAMPLE EMBODIMENT

Some example embodiments will be described with reference to the drawings.

### Observation System 1

First, an example of a configuration of an observation system 1 including any of information providing devices 10, 20, 30, 40, and 50 according to first to fifth example embodiments described below will be described.

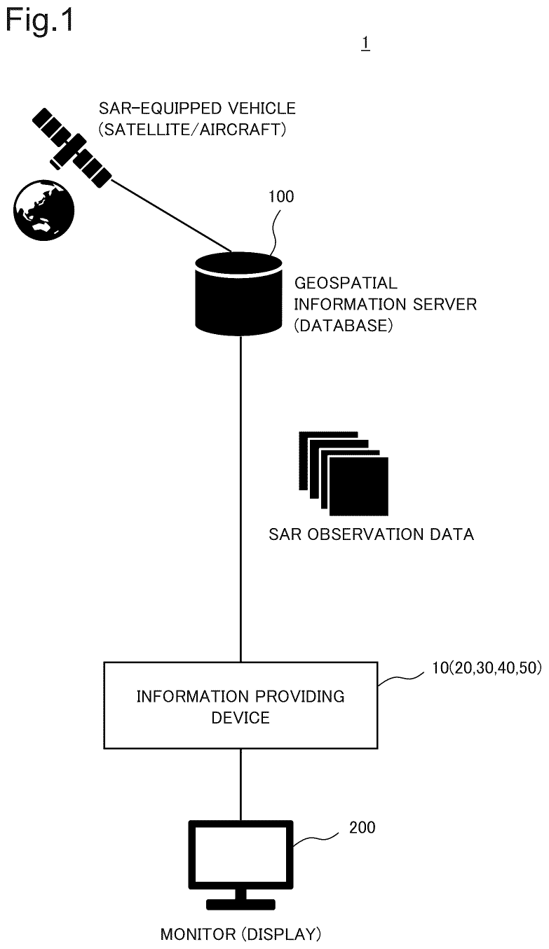

FIG. 1 is a diagram schematically illustrating an example of the configuration of the observation system 1. Any of the information providing devices 10, 20, 30, 40, and 50 according to the first to fifth example embodiments described below can be applied to the observation system 1.

As illustrated in FIG. 1, the observation system 1 includes the information providing device 10 (20, 30, 40, or 50), a geospatial information server 100, and a monitor 200. Here, the “information providing device 10 (20, 30, 40, or 50)” represents any of the information providing devices 10, 20, 30, 40, and 50 according to the first to fifth example embodiments.

The geospatial information server 100 stores data received from synthetic aperture radar (SAR)-equipped vehicle (for example, a satellite or aircraft). The SAR-equipped vehicle observes a target object by irradiating the target object with microwaves (radio waves) while moving above, and analyzing a signal of reflected waves. Here, the target object is the earth's surface. The earth's surface includes not only the ground surface but also an artificial object such as a pavement or a building.

SAR observation data includes SAR image data captured in an observed region, information for specifying the position of the earth's surface, and information indicating a distance from the SAR to the earth's surface. Further, the SAR observation data includes information indicating a date and time when observation is performed.

The information providing device 10 (20, 30, 40, or 50) acquires the SAR observation data from the geospatial information server 100. The information providing device 10 (20, 30, 40, or 50) causes a display 200 to display a screen for providing information to a user. Some specific examples of the screen displayed on the display 200 by the information providing device 10 (20, 30, 40, and 50) will be described in the first to fifth example embodiments described below.

### First Example Embodiment

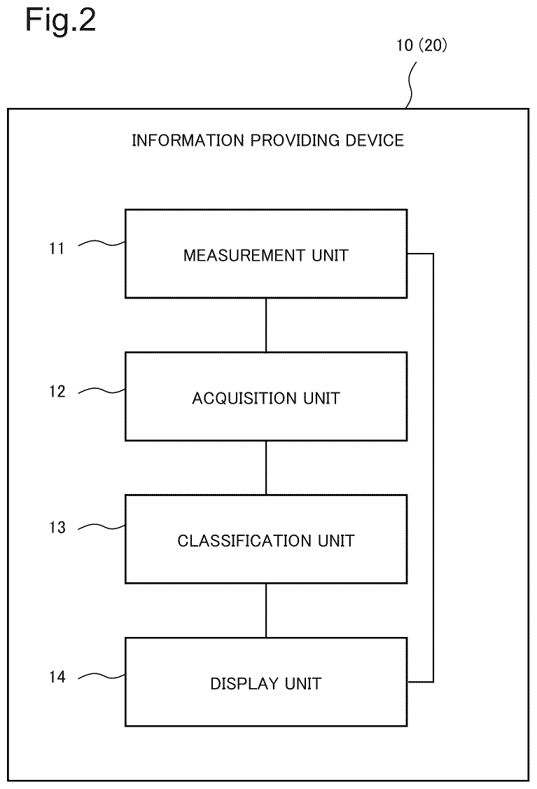

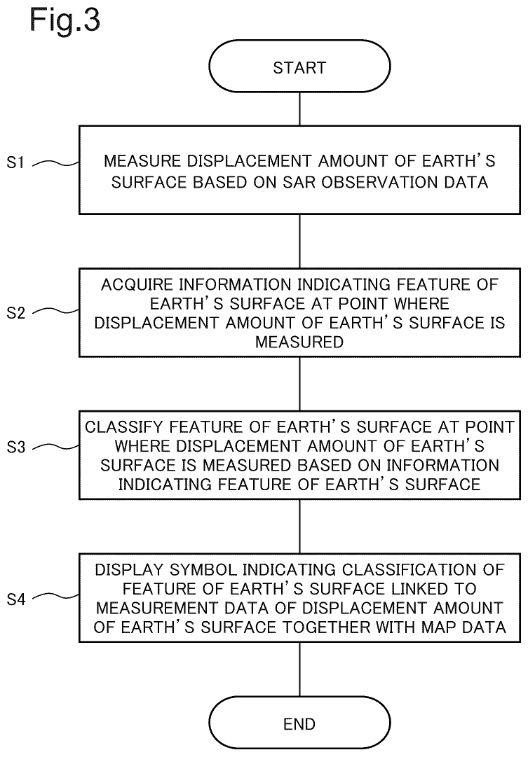

The first example embodiment will be described with reference to FIGS. 2 and 3.

### Information Providing Device 10

A configuration of the information providing device 10 according to the first example embodiment will be described with reference to FIG. 2. FIG. 2 is a block diagram illustrating the configuration of the information providing device 10.

As illustrated in FIG. 2, the information providing device 10 includes a measurement unit 11, an acquisition unit 12, a classification unit 13, and a display unit 14.

The measurement unit 11 measures a displacement amount of the earth's surface based on the SAR observation data. The measurement unit 11 is an example of measurement means.

In an example, the measurement unit 11 measures the displacement amount of the earth's surface by interferometric SAR. The displacement amount of the earth's surface represents the magnitude of displacement (that is, uplift or sinking) of the earth's surface in a vertical direction. The interferometric SAR is also called InSAR, and is a technology for analyzing displacement and variation of the earth's surface in a wide range. Schematically, the displacement amount of the earth's surface is measured based on deviation between positions of the earth's surface indicated by two or more pieces of observation data for the same region.

The measurement unit 11 outputs measurement data of the displacement amount of the earth's surface to the acquisition unit 12 and the display unit 14 together with the SAR observation data.

The acquisition unit 12 acquires information indicating a feature of the earth's surface at a point where the displacement amount of the earth's surface is measured. The acquisition unit 12 is an example of acquisition means.

The acquisition unit 12 may acquire information indicating the magnitude of relevance between time-series data of the displacement amount of the earth's surface and time-series data of a temperature at the point where the displacement amount of the earth's surface is measured. The acquisition unit 12 may acquire information indicating the magnitude of relevance between time-series observation data of the displacement amount of the earth's surface and time-series data of a precipitation amount at the point where the displacement amount of the earth's surface is measured. The acquisition unit 12 may acquire information indicating a difference between the measurement data of the displacement amount of the earth's surface and prediction data of the displacement amount of the earth's surface.

In an example, the acquisition unit 12 receives the measurement data of the displacement amount of the earth's surface and the SAR observation data from the measurement unit 11. The acquisition unit 12 extracts the SAR image data captured in the observed region and the information for specifying the position of the earth's surface from the SAR observation data. The acquisition unit 12 specifies the position of the point where the displacement amount of the earth's surface is measured by using these pieces of information.

Furthermore, the acquisition unit 12 collects information indicating the feature of the earth's surface at the point where the displacement amount of the earth's surface is measured by referring to an external information server, database, or the like (not illustrated). For example, the feature of the earth's surface is weather data such as the temperature, humidity, and precipitation amount. In another example, the feature of the earth's surface is geological data such as a composition of the earth's surface, the amount of groundwater water, or an embanked region. In still another example, the feature of the earth's surface is land use data such as land use, pavement, or traffic volume.

In addition, in a case where the prediction data of the displacement amount of the earth's surface is available, the acquisition unit 12 may also acquire the observation data. The prediction data of the displacement amount of the earth's surface represents the current or future displacement amount (non-actual measurement value) of the earth's surface predicted from the past measurement data of the displacement amount of the earth's surface. The prediction data of the displacement amount of the earth's surface is used to perform comparison with the measurement data of the displacement amount of the earth's surface (second example embodiment).

Then, the acquisition unit 12 outputs the information indicating the feature of the earth's surface at the point where the displacement amount of the earth's surface is measured to the classification unit 13.

The classification unit 13 classifies the feature of the earth's surface based on information indicating the feature of the earth's surface. The classification unit 13 is an example of classification means.

In an example, the classification unit 13 receives, from the acquisition unit 12, the information indicating the feature of the earth's surface at the point where the displacement amount of the earth's surface is measured. The classification unit 13 classifies the feature of the earth's surface based on information indicating the feature of the earth's surface. For example, the classification unit 13 classifies the feature of the earth's surface based on the “highest (lowest) temperature” of the earth's surface. Furthermore, the classification unit 13 classifies the feature of the earth's surface based on an “average precipitation amount” of the earth's surface. In this manner, the classification unit 13 classifies the feature of the earth's surface at the point where the displacement amount of the earth's surface is measured by using some indexes.

The classification unit 13 outputs, to the display unit 14, information indicating a classification of the feature of the earth's surface at the point where the displacement amount of the earth's surface is measured.

The display unit 14 displays a symbol representing the classification of the feature of the earth's surface linked to the measurement data of the displacement amount of the earth's surface together with map data. The display unit 14 is an example of display means. The display unit 14 may display a symbol representing the feature of the earth's surface together with the map data. The display unit 14 may display multicolored map data indicating the magnitude of a difference between the measurement data of the displacement amount of the earth's surface and the prediction data of the displacement amount of the earth's surface.

In an example, the display unit 14 receives the measurement data of the displacement amount of the earth's surface and the SAR observation data from the measurement unit 11.

The display unit 14 generates a graph representing the displacement amount of the earth's surface based on the measurement data of the displacement amount of the earth's surface. For example, the graph generated by the display unit 14 may represent time series of the displacement amount of the earth's surface, or may represent a relationship between the displacement amount of the earth's surface and the position of the point where the displacement amount of the earth's surface is measured.

In addition, the display unit 14 receives, from the classification unit 13, the information indicating the classification of the feature of the earth's surface at the point where the displacement amount of the earth's surface is measured.

The display unit 14 displays the information indicating the classification of the feature of the earth's surface at the point where the displacement amount of the earth's surface is measured, together with an SAR image representing the region observed by the SAR. For example, a symbol, a code, or a graphic representing the classification of the feature of the earth's surface is superimposed on the SAR image.

The display unit 14 generates image data for displaying these pieces of information, and transmits the image data to the display 200 (FIG. 1). Some specific examples of the image data displayed on the display 200 by the display unit 14 will be described in the second example embodiment.

### Operation of Information Providing Device 10

An example of an operation of the information providing device 10 according to the first example embodiment will be described with reference to FIG. 3. FIG. 3 is a flowchart illustrating the operation of the information providing device 10.

As illustrated in FIG. 3, first, the measurement unit 11 measures the displacement amount of the earth's surface based on the SAR observation data (S1). The measurement unit 11 outputs measurement data of the displacement amount of the earth's surface to the acquisition unit 12 and the display unit 14 together with the SAR observation data.

Next, the acquisition unit 12 acquires information indicating a feature of the earth's surface at a point where the displacement amount of the earth's surface is measured (S2). The acquisition unit 12 outputs the information indicating the feature of the earth's surface at the point where the displacement amount of the earth's surface is measured to the classification unit 13.

The classification unit 13 classifies the feature of the earth's surface at the point where the displacement amount of the earth's surface is measured based on the information indicating the feature of the earth's surface (S3). The classification unit 13 outputs, to the display unit 14, information indicating a classification of the feature of the earth's surface at the point where the displacement amount of the earth's surface is measured.

Finally, the display unit 14 displays a symbol representing the classification of the feature of the earth's surface linked to the measurement data of the displacement amount of the earth's surface together with the map data (S4).

As described above, the operation of the information providing device 10 according to the first example embodiment ends.

### Effects of Present Example Embodiment

According to the configuration of the present example embodiment, the measurement unit 11 measures the displacement amount of the earth's surface based on the SAR observation data. The acquisition unit 12 acquires information indicating a feature of the earth's surface at a point where the displacement amount of the earth's surface is measured. The classification unit 13 classifies the feature of the earth's surface at the point where the displacement amount of the earth's surface is measured based on the information indicating the feature of the earth's surface. The display unit 14 displays a symbol representing the classification of the feature of the earth's surface linked to the measurement data of the displacement amount of the earth's surface together with map data. The symbol representing the classification of the feature of the earth's surface helps the user of the SAR observation data to understand the meaning of the measurement data of the displacement amount of the earth's surface. As a result, it is possible to provide the user of the SAR observation data with information regarding the displacement of the earth's surface.

### Second Example Embodiment

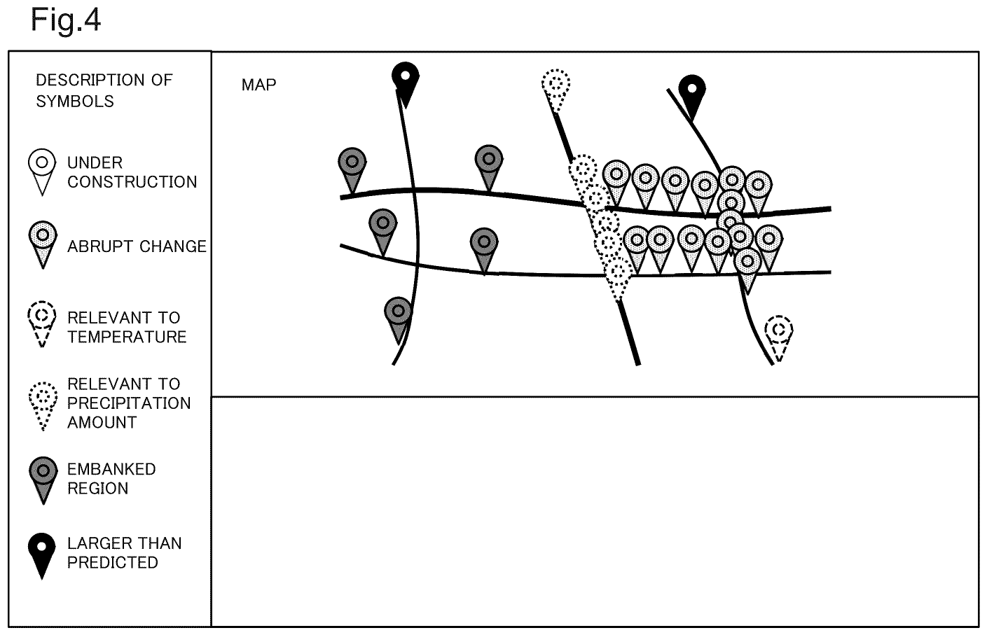

The second example embodiment will be described with reference to FIGS. 4 to 6. In the second example embodiment, a specific example of image data displayed on a display 200 (FIG. 1) by the information providing device 20 (FIG. 2) will be described. A configuration of the information providing device 20 according to the second example embodiment is the same as the configuration of the information providing device 10 according to the first example embodiment. Therefore, in the second example embodiment, a description regarding the configuration of the information providing device 10 according to the first example embodiment is cited, and a description regarding the configuration of the information providing device 20 is omitted.

### First Example: Display of Symbol Representing Feature of Earth's Surface

FIG. 4 is a view illustrating an example of a screen displayed on the display 200 (FIG. 1) by the information providing device 20 according to the second example embodiment.

In FIG. 4, symbols are described on the left side. On the upper right side, the symbols are arranged on map data. A position of a symbol on the map data represents a point where a displacement amount of the earth's surface is measured.

In this example, six symbols are illustrated. Each symbol is associated to a classification of a feature of the earth's surface. That is, each of “under construction”, “abrupt change”, “relevancy to temperature”, “relevant to precipitation”, “embanked region”, and “larger than predicted” represents the classification of the feature of the earth's surface.

“Under construction” means that some construction is being performed at the point where the displacement amount of the earth's surface is measured. “Abrupt change” means that the displacement amount of the earth's surface is larger than a threshold. The threshold may be, for example, twice an average value and may be determined by any method. “Relevant to temperature” means that a change of the displacement amount of the earth's surface over time is associated with a change of the temperature over time. Here, “associated” represents that patterns of the changes over time are similar, for example, that a correlation value is equal to or more than a certain value.

“Relevant to precipitation amount” means that the change of the displacement amount of the earth's surface over time is associated with a change of the precipitation amount over time. “Embanked region” means that the point where the displacement amount of the earth's surface is measured is an embanked region. “Larger than predicted” means that a measured displacement amount of the earth's surface is larger than a predicted displacement amount of the earth's surface.

In a modification, the symbol is different in at least one of shape, pattern, color, or size for each classification of the feature of the earth's surface. More generally speaking, the symbols differ in form for each classification of the feature of the earth's surface. Alternatively, the symbol may be an icon that abstracts or generalizes the associated classification of the feature of the earth's surface. For example, an icon represented by a picture of a thermometer is associated to “relevant to temperature”. Using such an expression using an icon has an advantage that a user who visually recognizes the image data can easily recognize at a glance the classification of the feature of the earth's surface represented by the icon.

Second Example: Display of Change of Displacement Amount of Earth's Surface over Time

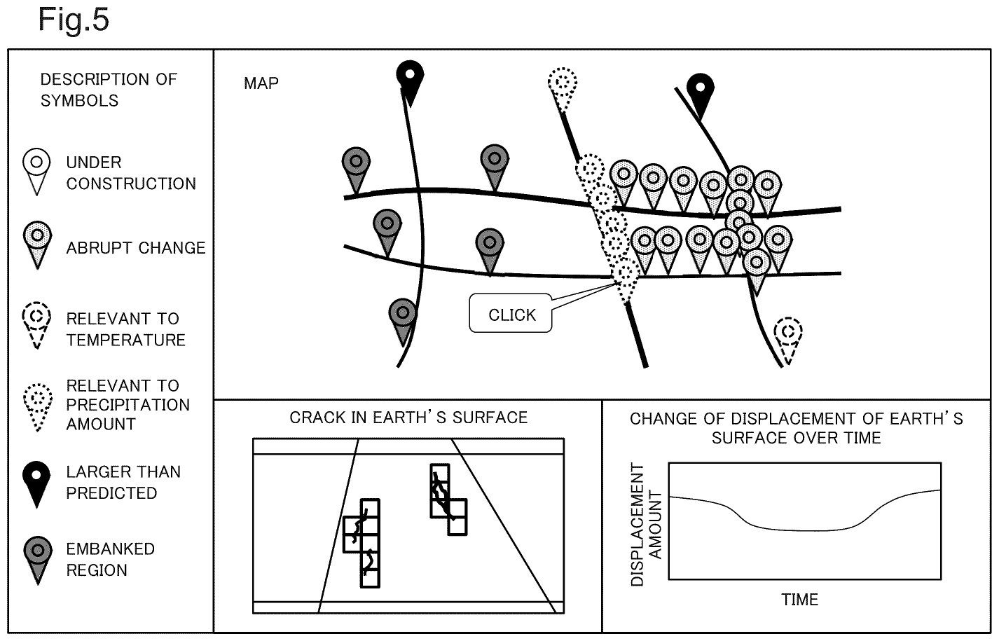

FIG. 5 is a view illustrating another example of the screen displayed on the display 200 (FIG. 1) by the information providing device 20 according to the second example embodiment.

In FIG. 5, information indicating a position where there is a crack in the earth's surface and a graph representing a change of the displacement amount of the earth's surface over time are displayed side by side on the lower right side.

In the first example described above, when any symbol on the map data illustrated in FIG. 4 is clicked, information regarding the earth's surface at the point indicated by the symbol is displayed below the map data as illustrated in FIG. 5. By checking the information displayed under the map data, the user can detect the cause of the displacement of the earth's surface and determine how dangerous the displacement of the earth's surface is.

Although an example in which a symbol is clicked has been described here, the type of input operation for selection is not limited thereto.

### Third Example: Display of Displacement Amount of Earth's Surface on Line

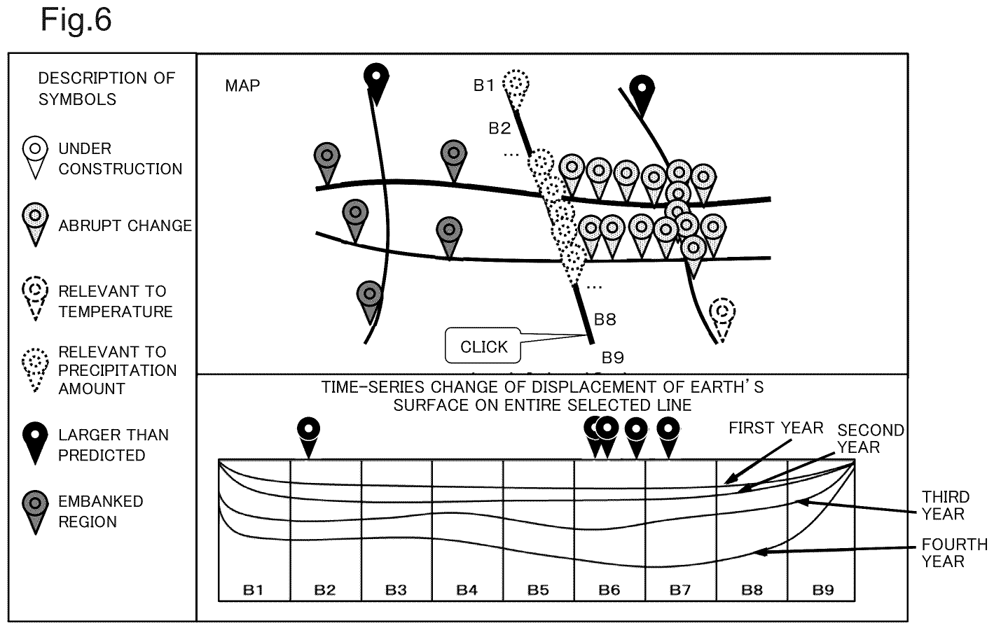

FIG. 6 is a view illustrating still another example of the screen displayed on the display 200 (FIG. 1) by the information providing device 20 according to the second example embodiment.

In FIG. 6, a graph representing the displacement amount of the earth's surface on a certain line is displayed on the lower right side. In the example illustrated in FIG. 6, a graph representing displacement amounts for four years from the first year to the fourth year is illustrated. The lines illustrated in FIG. 6 connect between regions where the displacement amounts of the earth's surface are measured (for example, B1 to B9).

In the first example described above, when any line on the map data illustrated in FIG. 4 is clicked, as illustrated in FIG. 6, a graph representing the displacement amount of the earth's surface on the line is displayed below the map data. Further, the symbols representing the classifications of the features of the earth's surface are illustrated above the graph. By checking the information displayed under the map data, the user can detect the cause of the displacement of the earth's surface and determine how dangerous the displacement of the earth's surface is.

According to the configuration of this example, the user can easily know how the displacement amount of the earth's surface changes with time over a plurality of regions.

### Effects of Present Example Embodiment

According to the configuration of the present example embodiment, the measurement unit 11 measures the displacement amount of the earth's surface based on the SAR observation data. The acquisition unit 12 acquires information indicating a feature of the earth's surface at a point where the displacement amount of the earth's surface is measured. The classification unit 13 classifies the feature of the earth's surface at the point where the displacement amount of the earth's surface is measured based on the information indicating the feature of the earth's surface. The display unit 14 displays a symbol representing the classification of the feature of the earth's surface linked to the measurement data of the displacement amount of the earth's surface together with map data. The symbol representing the classification of the feature of the earth's surface helps the user of the SAR observation data to understand the meaning of the measurement data of the displacement amount of the earth's surface. As a result, it is possible to provide the user of the SAR observation data with information regarding the displacement of the earth's surface.

### Third Example Embodiment

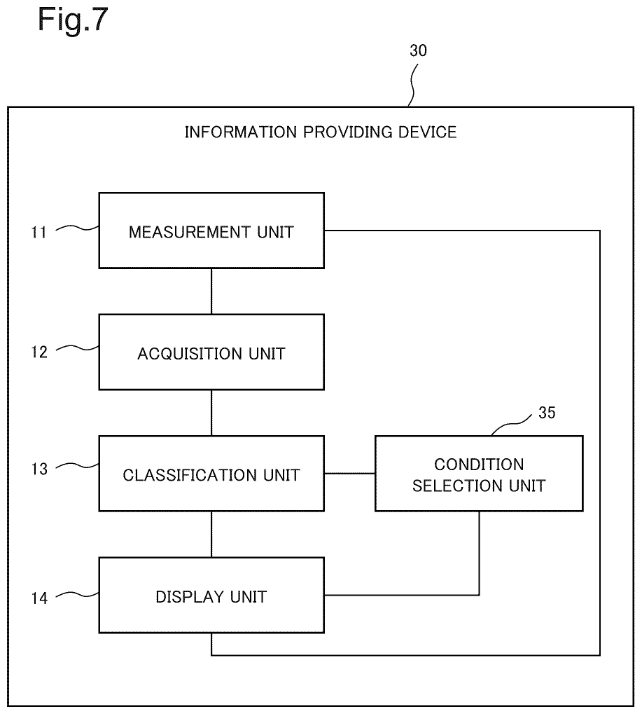

The third example embodiment will be described with reference to FIGS. 7 to 12. In the third example embodiment, a configuration in which a user can select a symbol associated to a classification of a feature of the earth's surface to be displayed will be described. In the third example embodiment, the same configuration as those in the first and second example embodiments are denoted by the same reference numerals, and a description thereof will be omitted.

### Information Providing Device 30

A configuration of the information providing device 30 according to the third example embodiment will be described with reference to FIG. 7. FIG. 7 is a block diagram illustrating the configuration of the information providing device 30.

As illustrated in FIG. 7, the information providing device 30 includes a measurement unit 11, an acquisition unit 12, a classification unit 13, and a display unit 14. The information providing device 30 further includes a condition selection unit 35.

The condition selection unit 35 causes the user to select one or more conditions associated to the feature of the earth's surface. The condition selection unit 35 is an example of condition selection means.

In an example, the condition selection unit 35 receives information indicating the classification of the feature of the earth's surface from the classification unit 13. The condition selection unit 35 instructs the display unit 14 to display one or more conditions associated to the classification of the feature of the earth's surface on a one-to-one basis. When the user performs an input operation for selecting any one or a plurality of conditions on an input device (not illustrated) connected to the information providing device 30, the condition selection unit 35 acquires information indicating the condition selected by the user. The condition selection unit 35 outputs information indicating the selected condition to the display unit 14.

The display unit 14 receives the information indicating the selected condition from the condition selection unit 35. The display unit 14 displays a symbol associated to the classification of the feature of the earth's surface associated to the selected condition together with map data.

### Operation of Information Providing Device 30

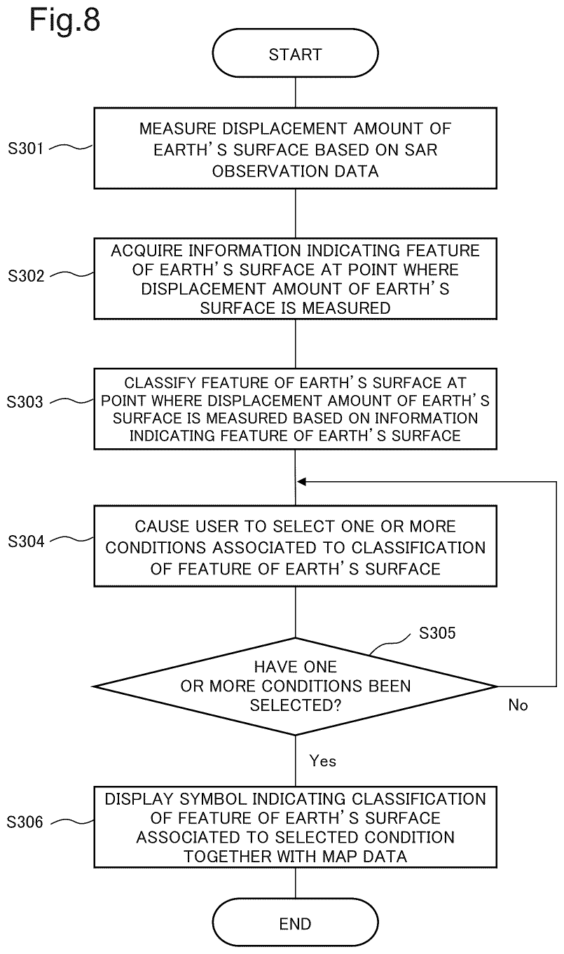

An example of an operation of the information providing device 30 according to the third example embodiment will be described with reference to FIG. 8. FIG. 8 is a flowchart illustrating the operation of the information providing device 30.

As illustrated in FIG. 8, first, the measurement unit 11 measures a displacement amount of the earth's surface based on SAR observation data (S301). The measurement unit 11 outputs measurement data of the displacement amount of the earth's surface to the acquisition unit 12 and the display unit 14 together with the SAR observation data.

Next, the acquisition unit 12 acquires information indicating a feature of the earth's surface at a point where the displacement amount of the earth's surface is measured (S302). The acquisition unit 12 outputs the information indicating the feature of the earth's surface at the point where the displacement amount of the earth's surface is measured to the classification unit 13.

The classification unit 13 classifies the feature of the earth's surface at the point where the displacement amount of the earth's surface is measured based on the information indicating the feature of the earth's surface (S303). The classification unit 13 outputs information indicating a classification of the feature of the earth's surface at the point where the displacement amount of the earth's surface is measured to the condition selection unit 35 and the display unit 14.

The condition selection unit 35 causes the user to select one or more conditions associated to the feature of the earth's surface (S304).

Thereafter, the condition selection unit 35 determines whether one or more conditions have been selected (S305). Unless one or more conditions are selected (No in S305), the flow returns to S304.

In a case where one or more conditions have been selected (Yes in S305), the display unit 14 displays a symbol representing the classification of the feature of the earth's surface associated to the selected condition together with the map data (S306).

As described above, the operation of the information providing device 30 according to the third example embodiment ends.

### First Example: Screen for Selecting Condition

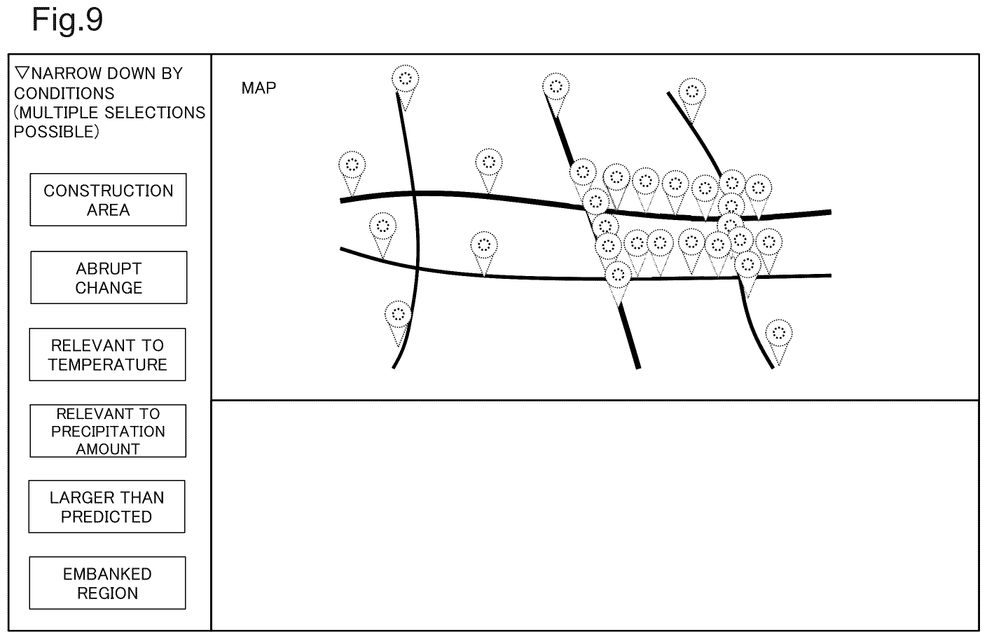

FIG. 9 is a view illustrating an example of a screen displayed on a display 200 (FIG. 1) by the information providing device 30 according to the third example embodiment.

In FIG. 9, a list of conditions is described on the left side. On the upper right side, the symbols are arranged on map data. In practice, no symbols are displayed until one or more conditions are subsequently selected.

In this example, six conditions are illustrated. Each condition is associated to a classification of a feature of the earth's surface. That is, each of “under construction”, “abrupt change”, “relevancy to temperature”, “relevant to precipitation”, “embanked region”, and “larger than predicted” is an example of the classification of the feature of the

That is, each condition is associated to the symbol described in the second example embodiment.

In FIG. 9, “narrow down by conditions” is described in the upper part on the left side. The description is displayed to request the user to select a condition. As described above, the condition selection unit 35 instructs the display unit 14 to display one or more conditions associated to the classification of the feature of the earth's surface on a one-to-one basis. At this time, the display unit 14 displays image data illustrated in FIG. 9 on the display 200 (FIG. 1).

### Second Example: Selection of Construction Area

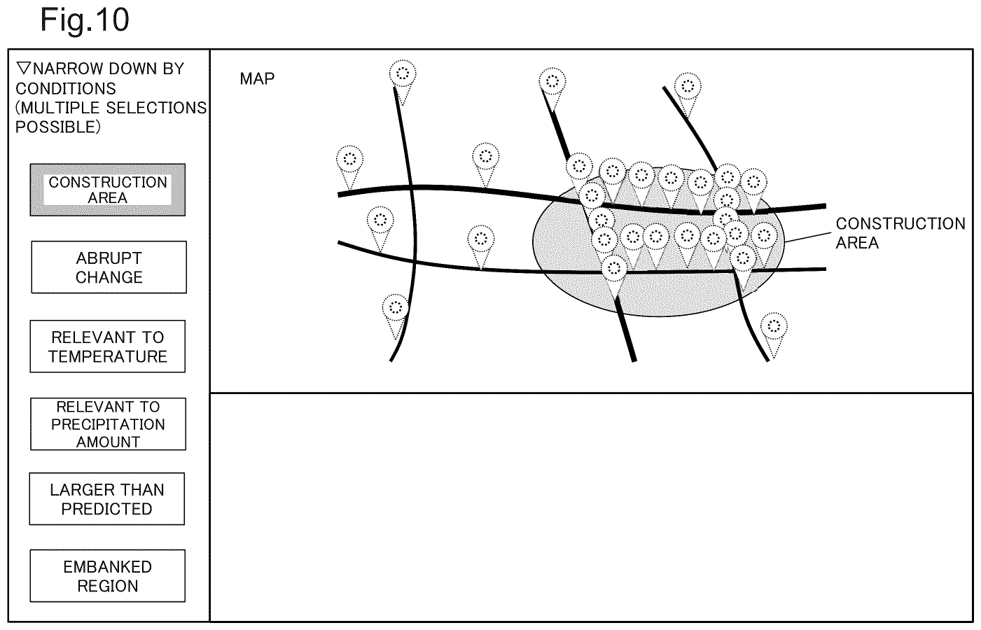

FIG. 10 is a view illustrating another example of the screen displayed on the display 200 (FIG. 1) by the information providing device 30 according to the third example embodiment.

FIG. 10 illustrates a state in which “construction area” is selected from the list of conditions described on the left side. The “construction area” represents an area where a construction company or a real estate company, which is the user, is performing construction or is scheduled to perform construction. A circle indicating the construction area is displayed on the map data on the right side.

In the first example described above, when only the “construction area” among the symbols illustrated in FIG. 9 is clicked, the circle indicating the construction area is displayed under the map data as illustrated in FIG. 10. The user can first select “construction area” to limit a region in which the symbol is to be displayed to “construction area”.

Although an example in which a symbol is clicked has been described here, the type of input operation for selection is not limited thereto.

### Third Example; Selection of Other Conditions

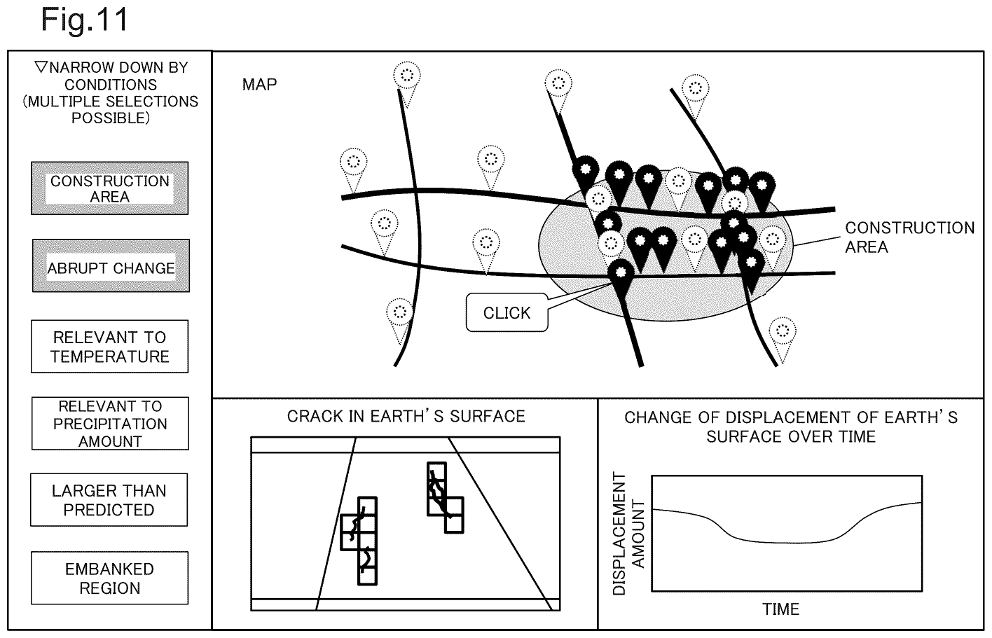

FIG. 11 is a view illustrating still another example of the screen displayed on the display 200 (FIG. 1) by the information providing device 30 according to the third example embodiment.

FIG. 11 illustrates a state in which “abrupt change” is selected in addition to “construction area” in the list of conditions described on the left side. In the second example embodiment, “abrupt change” means that the displacement amount of the earth's surface is larger than a threshold as described with respect to the symbol. On the right side, a symbol associated to “abrupt change” in the circle indicating the construction area is displayed on the map data.

In the second example described above, when “abrupt change” among the symbols illustrated in FIG. 10 is clicked, the symbol associated to “abrupt change” is displayed only in the construction area as illustrated in FIG. 11. In other words, the symbol associated to “abrupt change” outside the construction area is not displayed. As a result, only information desired by the user (in this example, “abrupt change” in a region where construction involving the own company is being performed or scheduled to be performed) can be selectively provided to the user.

### Modifications

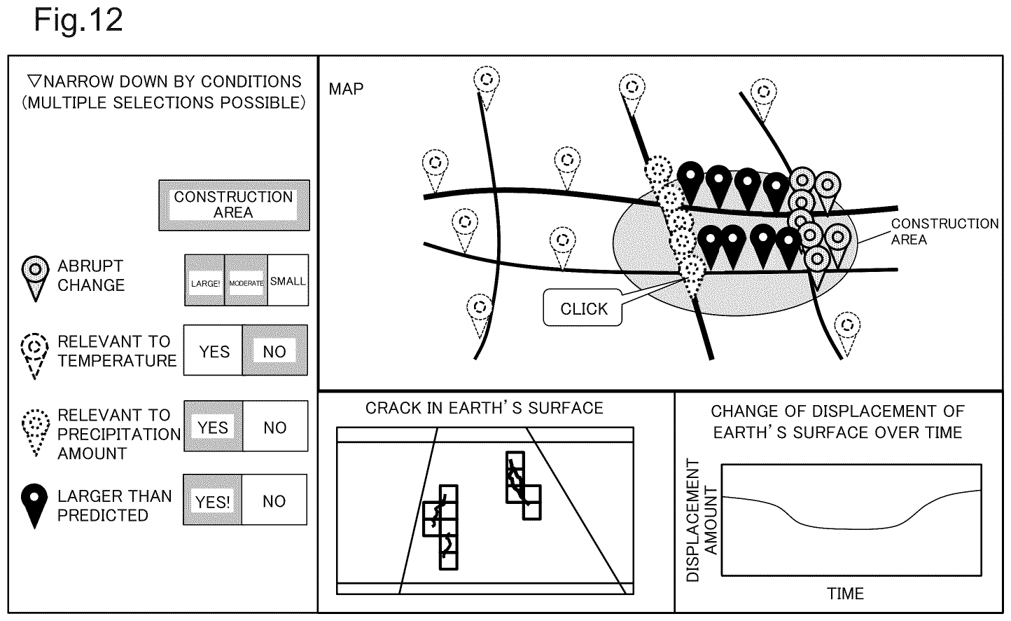

FIG. 12 is a view illustrating a modification of the screen displayed on the display 200 (FIG. 1) by the information providing device 30 according to the third example embodiment.

In this modification, the symbol associated to the classification of the feature of the earth's surface is displayed in a different mode for each of the classification of the feature of the earth's surface, as in the second example embodiment.

In this modification, when any symbol on the map data is clicked, information regarding the earth's surface at a point indicated by the symbol is displayed under the map data. Since the information regarding the earth's surface at the point indicated by the symbol has been described in the second example embodiment, a description thereof will be omitted here.

Although an example in which a symbol is clicked has been described here, the type of input operation for selection is not limited thereto.

In another modification, in a case where there is a matter that the user needs to pay attention to regarding a classification of a certain feature of the earth's surface, an alert may be notified to the user. For example, a condition for the alert is that the displacement amount of the earth's surface within a certain period exceeds a reference value for a warning. In this case, an alert regarding “abrupt change” among the conditions illustrated in FIG. 12 is notified. A method for the alert notification is not particularly limited, and a message such as “!” may be displayed as illustrated in FIG. 12.

### Effects of Present Example Embodiment

According to the configuration of the present example embodiment, the measurement unit 11 measures the displacement amount of the earth's surface based on the SAR observation data. The acquisition unit 12 acquires information indicating a feature of the earth's surface at a point where the displacement amount of the earth's surface is measured. The classification unit 13 classifies the feature of the earth's surface at the point where the displacement amount of the earth's surface is measured based on the information indicating the feature of the earth's surface. The display unit 14 displays a symbol representing the classification of the feature of the earth's surface linked to the measurement data of the displacement amount of the earth's surface together with map data. The symbol representing the classification of the feature of the earth's surface helps the user of the SAR observation data to understand the meaning of the measurement data of the displacement amount of the earth's surface. As a result, it is possible to provide the user of the SAR observation data with information regarding the displacement of the earth's surface.

According to the configuration of the present example embodiment, the condition selection unit 35 causes the user to select one or more conditions associated to the feature of the earth's surface. The display unit 14 displays a symbol representing the classification of the feature of the earth's surface associated to the selected condition together with the map data. As a result, only information desired by the user can be selectively provided.

### Fourth Example Embodiment

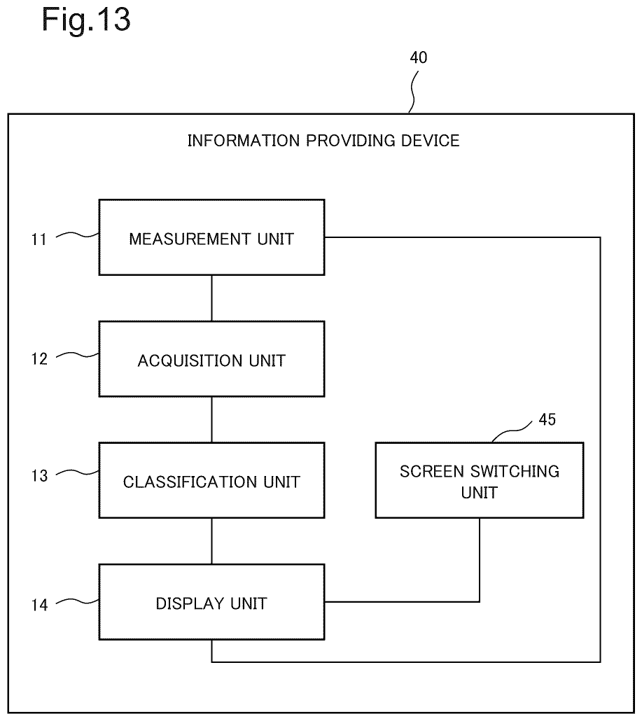

The fourth example embodiment will be described with reference to FIGS. 13 to 15. In the fourth example embodiment, a configuration in which a user can switch a screen based on a plurality of different evaluation indexes in order to enable the user to analyze a feature of the earth's surface at a more advanced level will be described. In the fourth example embodiment, the same configuration as those in the first to third example embodiments are denoted by the same reference numerals, and a description thereof will be omitted.

### Information Providing Device 40

A configuration of the information providing device 40 according to the fourth example embodiment will be described with reference to FIG. 13. FIG. 13 is a block diagram illustrating the configuration of the information providing device 40.

As illustrated in FIG. 13, the information providing device 40 includes a measurement unit 11, an acquisition unit 12, a classification unit 13, and a display unit 14. The information providing device 40 further includes a screen switching unit 45.

In the fourth example embodiment, the display unit 14 displays (FIGS. 4 to 6, and 9 to 12) a symbol and map data as in the second and third example embodiments. In addition, the display unit 14 displays multicolored map data indicating the magnitude of a difference between measurement data of a displacement amount of the earth's surface and prediction data of the displacement amount of the earth's surface. An example of the multicolored map will be described later.

The display unit 14 displays option buttons for switching between a first screen on which the symbol and the map data are displayed and a second screen on which the multicolored map is displayed.

The screen switching unit 45 performs switching between the first screen and the second screen based on an input operation on the option buttons. That is, the screen switching unit 45 performs switching to one of the first screen and the second screen according to a selected position of the option buttons.

### Example of First Screen

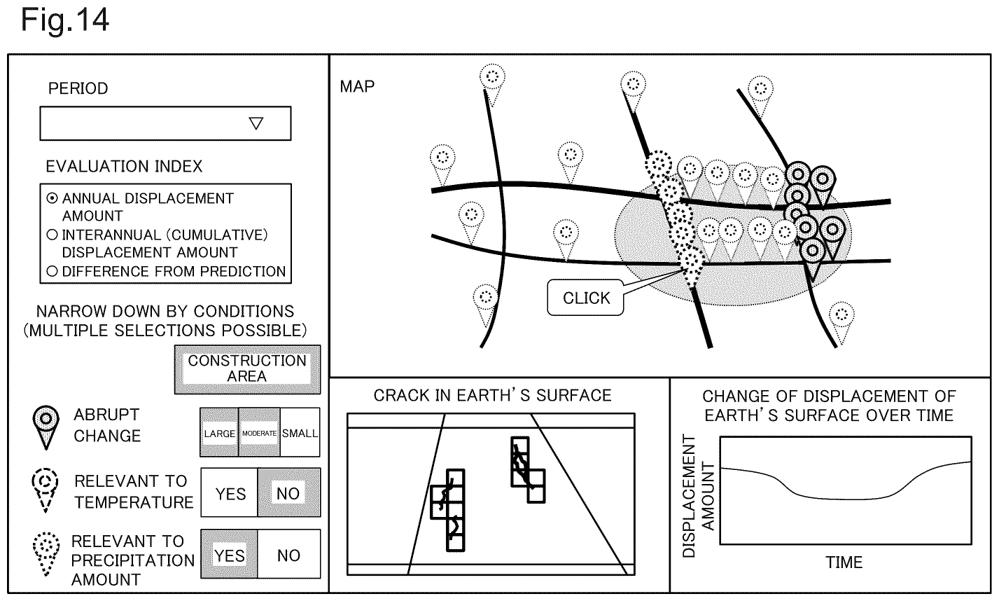

FIG. 14 illustrates an example of the first screen on which the symbol and the map data are displayed. The first screen illustrated in FIG. 14 is equivalent to the screen illustrated in FIG. 12 except for “period” and “evaluation index” on the left side.

In FIG. 14, the option buttons for selecting “evaluation index” is arranged in addition to a tab for selecting “period” to be displayed. “Evaluation index” is an index for the user to evaluate the feature of the earth's surface. “Evaluation index” here includes “annual displacement amount”, “interannual (cumulative) displacement amount”, and “difference from prediction”.

“Annual displacement amount” means the displacement amount of the earth's surface in a specific (for example, most recent) year. “Interannual (cumulative) displacement amount” means the accumulation of the displacement amounts of the earth's surface in the period (designated from the tab). “Difference from prediction” means a difference between the prediction data of the displacement amount of the earth's surface and the measurement data of the displacement amount of the earth's surface. The prediction data of the displacement amount of the earth's surface represents the current or future displacement amount (non-actual measurement value) of the earth's surface predicted from the past measurement data of the displacement amount of the earth's surface.

When the option button of “annual displacement amount” or “interannual (cumulative) displacement amount” is selected, the display unit 14 displays the first screen illustrated in FIG. 14 on a display 200 (FIG. 1).

### Example of Second Screen

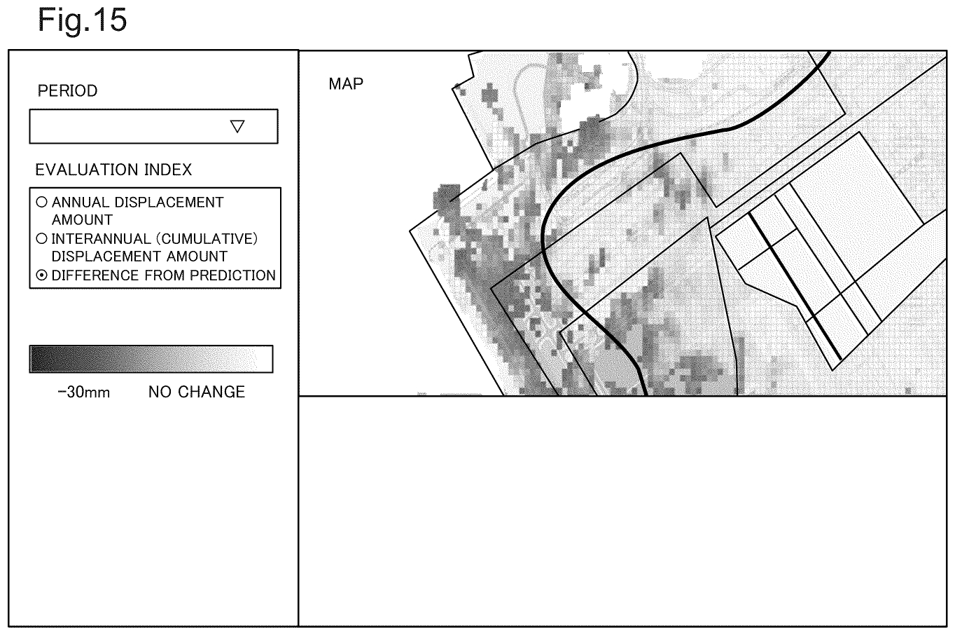

FIG. 15 illustrates an example of the second screen on which the multicolored map data indicating the magnitude of the difference between the measurement data of the displacement amount of the earth's surface and the prediction data of the displacement amount of the earth's surface is displayed.

In a case where the option button of “difference from prediction” is selected, the display unit 14 displays the second screen illustrated in FIG. 15 on the display 200 (FIG. 1).

A selection change from the option button of “annual displacement amount” or “interannual (cumulative) displacement amount” to the option button of “difference from prediction” is made by an input operation of the user. In this case, the screen switching unit 45 performs switching from the first screen (FIG. 14) to the second screen (FIG. 15) based on an input operation on the option buttons. In the opposite case, the screen switching unit 45 performs switching from the second screen (FIG. 15) to the first screen (FIG. 14) based on an input operation on the option buttons.

The display unit 14 switches the first screen (second screen) to the second screen (first screen) based on screen switching information input from the screen switching unit 45.

### Effects of Present Example Embodiment

According to the configuration of the present example embodiment, the measurement unit 11 measures the displacement amount of the earth's surface based on the SAR observation data. The acquisition unit 12 acquires information indicating a feature of the earth's surface at a point where the displacement amount of the earth's surface is measured. The classification unit 13 classifies the feature of the earth's surface at the point where the displacement amount of the earth's surface is measured based on the information indicating the feature of the earth's surface. The display unit 14 displays a symbol representing the classification of the feature of the earth's surface linked to the measurement data of the displacement amount of the earth's surface together with map data. The symbol representing the classification of the feature of the earth's surface helps the user of the SAR observation data to understand the meaning of the measurement data of the displacement amount of the earth's surface. As a result, it is possible to provide the user of the SAR observation data with information regarding the displacement of the earth's surface.

According to the configuration of the present example embodiment, the display unit 14 displays the option buttons for switching between the first screen on which the symbol and the map data are displayed and the second screen on which the multicolored map is displayed. The screen switching unit 45 performs switching between the first screen and the second screen based on an input operation on the option buttons. As a result, information desired by the user can be selectively provided.

### Fifth Example Embodiment

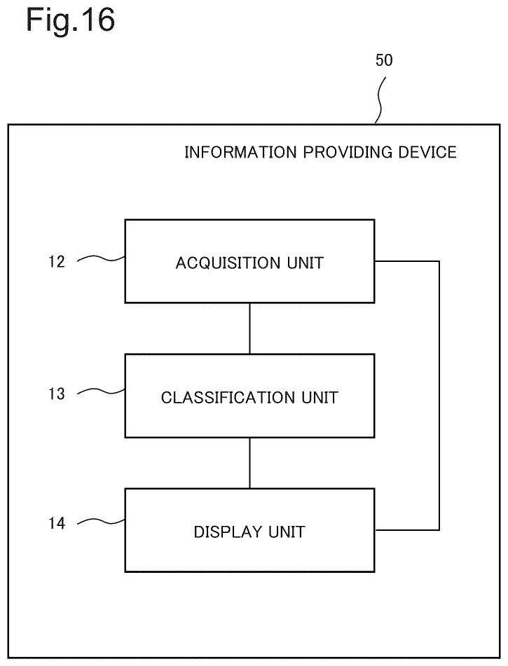

The fifth example embodiment will be described with reference to FIG. 16. In the fifth example embodiment, a measurement unit 11 (FIGS. 2, 7, and 13) is not included in the components of the information providing device 50. The information providing device 50 receives, from the outside, data of a displacement amount of the earth's surface measured based on SAR observation data.

### Information Providing Device 50

A configuration of the information providing device 50 according to the fifth example embodiment will be described with reference to FIG. 16. FIG. 16 is a block diagram illustrating the configuration of the information providing device 50.

As illustrated in FIG. 16, the information providing device 50 includes an acquisition unit 12, a classification unit 13, and a display unit 14.

The acquisition unit 12 acquires data of the displacement amount of the earth's surface measured based on the SAR observation data. The acquisition unit 12 is an example of acquisition means.

In an example, the acquisition unit 12 acquires data of a displacement amount of the earth's surface measured by interferometric SAR. The displacement amount of the earth's surface represents the magnitude of displacement (that is, uplift or sinking) of the earth's surface in a vertical direction. The interferometric SAR is also called InSAR, and is a technology for analyzing displacement and variation of the earth's surface in a wide range. Schematically, the displacement amount of the earth's surface is measured based on deviation between positions of the earth's surface indicated by two or more pieces of observation data for the same region.

The acquisition unit 12 outputs measurement data of the displacement amount of the earth's surface to the display unit 14 together with the SAR observation data.

The acquisition unit 12 acquires information indicating a feature of the earth's surface at a point where the displacement amount of the earth's surface is measured.

The acquisition unit 12 may acquire information indicating the magnitude of relevance between time-series data of the displacement amount of the earth's surface and time-series data of a temperature at the point where the displacement amount of the earth's surface is measured. The acquisition unit 12 may acquire information indicating the magnitude of relevance between time-series observation data of the displacement amount of the earth's surface and time-series data of a precipitation amount at the point where the displacement amount of the earth's surface is measured. The acquisition unit 12 may acquire information indicating a difference between the measurement data of the displacement amount of the earth's surface and prediction data of the displacement amount of the

In an example, the acquisition unit 12 extracts SAR image data captured in the observed region and the information for specifying the position of the earth's surface from the SAR observation data. The acquisition unit 12 specifies the position of the point where the displacement amount of the earth's surface is measured by using these pieces of information.

Furthermore, the acquisition unit 12 collects information indicating the feature of the earth's surface at the point where the displacement amount of the earth's surface is measured by referring to an external information server, database, or the like (not illustrated). For example, the feature of the earth's surface is weather data such as the temperature, humidity, and precipitation amount. In another example, the feature of the earth's surface is geological data such as a composition of the earth's surface, the amount of groundwater water, or an embanked region. In still another example, the feature of the earth's surface is land use data such as land use, pavement, or traffic volume.

In addition, in a case where the prediction data of the displacement amount of the earth's surface is available, the acquisition unit 12 may also acquire the observation data. The prediction data of the displacement amount of the earth's surface represents the current or future displacement amount (non-actual measurement value) of the earth's surface predicted from the past measurement data of the displacement amount of the earth's surface. The prediction data of the displacement amount of the earth's surface is used to perform comparison with the measurement data of the displacement amount of the earth's surface (second example embodiment).

Then, the acquisition unit 12 outputs the information indicating the feature of the earth's surface at the point where the displacement amount of the earth's surface is measured to the classification unit 13.

The classification unit 13 classifies the feature of the earth's surface based on information indicating the feature of the earth's surface. The classification unit 13 is an example of classification means.

In an example, the classification unit 13 receives, from the acquisition unit 12, the information indicating the feature of the earth's surface at the point where the displacement amount of the earth's surface is measured. The classification unit 13 classifies the feature of the earth's surface based on information indicating the feature of the earth's surface. For example, the classification unit 13 classifies the feature of the earth's surface based on the “highest (lowest) temperature” of the earth's surface. Furthermore, the classification unit 13 classifies the feature of the earth's surface based on an “average precipitation amount” of the earth's surface. In this manner, the classification unit 13 classifies the feature of the earth's surface at the point where the displacement amount of the earth's surface is measured by using some indexes.

The classification unit 13 outputs, to the display unit 14, information indicating a classification of the feature of the earth's surface at the point where the displacement amount of the earth's surface is measured.

The display unit 14 displays a symbol representing the classification of the feature of the earth's surface linked to the measurement data of the displacement amount of the earth's surface together with map data. The display unit 14 is an example of display means. The display unit 14 may display a symbol representing the feature of the earth's surface together with the map data. The display unit 14 may display multicolored map data indicating the magnitude of a difference between the measurement data of the displacement amount of the earth's surface and the prediction data of the displacement amount of the earth's surface.

In an example, the display unit 14 receives the measurement data of the displacement amount of the earth's surface and the SAR observation data from the acquisition unit 12.

The display unit 14 generates a graph representing the displacement amount of the earth's surface based on the measurement data of the displacement amount of the earth's surface. For example, the graph generated by the display unit 14 may represent time series of the displacement amount of the earth's surface, or may represent a relationship between the displacement amount of the earth's surface and the position of the point where the displacement amount of the earth's surface is measured.

In addition, the display unit 14 receives, from the classification unit 13, the information indicating the classification of the feature of the earth's surface at the point where the displacement amount of the earth's surface is measured.

The display unit 14 displays the information indicating the classification of the feature of the earth's surface at the point where the displacement amount of the earth's surface is measured, together with an SAR image representing the region observed by the SAR. For example, a symbol, a code, or a graphic representing the classification of the feature of the earth's surface is superimposed on the SAR image. The display unit 14 generates image data for displaying these pieces of information, and transmits the image data to the display 200 (FIG. 1).

### Operation of Information Providing Device 50

A schematic operation of the information providing device 50 according to the fifth example embodiment is similar to the operation of the information providing device 10 (FIG. 2) according to the first example embodiment. However, in the information providing device 50, the acquisition unit 12 acquires data of the displacement amount of the earth's surface instead of measuring the displacement amount of the earth's surface based on the SAR observation data.

A detailed description of the operation of the information providing device 50 according to the fifth example embodiment will be omitted by referring to the description (FIG. 3) of the operation of the information providing device 10 according to the first example embodiment.

### Effects of Present Example Embodiment

According to the configuration of the present example embodiment, the acquisition unit 12 acquires data of the displacement amount of the earth's surface based on the SAR observation data. The acquisition unit 12 acquires information indicating a feature of the earth's surface at a point where the displacement amount of the earth's surface is measured. The classification unit 13 classifies the feature of the earth's surface at the point where the displacement amount of the earth's surface is measured based on the information indicating the feature of the earth's surface. The display unit 14 displays a symbol representing the classification of the feature of the earth's surface linked to the measurement data of the displacement amount of the earth's surface together with map data. The symbol representing the classification of the feature of the earth's surface helps the user of the SAR observation data to understand the meaning of the measurement data of the displacement amount of the earth's surface. As a result, it is possible to provide the user of the SAR observation data with information regarding the displacement of the earth's surface.

### Regarding Hardware Configuration

The components of the information providing devices 10, 20, 30, 40, and 50 described in the first to fifth example embodiments indicate functional unit blocks. Some or all of these components are implemented by an information processing device 900 as illustrated in

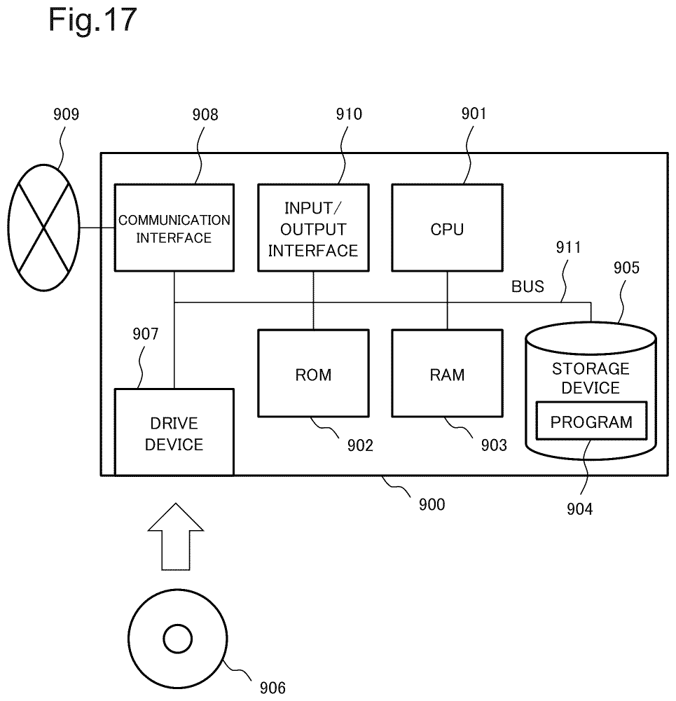

FIG. 17, for example. FIG. 17 is a block diagram illustrating an example of a hardware configuration of the information processing device 900.

As illustrated in FIG. 17, the information processing device 900 has the following configuration by way of example.
A central processing unit (CPU) 901
A read only memory (ROM) 902
A random access memory (RAM) 903
A program 904 loaded to the RAM 903
A storage device 905 storing the program 904
A drive device 907 that performs reading and writing on a recording medium 906
A communication interface 908 connected to a communication network 909
An input/output interface 910 for inputting/outputting data
A bus 911 connecting the components

The components of the information providing devices 10, 20, 30, 40, and 50 described in the first to fifth example embodiments are implemented by the CPU 901 reading and executing the program 904 for implementing these functions. The program 904 for implementing the functions of the components is stored in the storage device 905 or the ROM 902 in advance, for example, and the CPU 901 loads the program to the RAM 903 and executes the program as necessary. The program 904 may be supplied to the CPU 901 via the communication network 909, or may be stored in advance in the recording medium 906, and the drive device 907 may read the program and supply the program to the CPU 901.

According to the above configuration, the information providing devices 10, 20, 30, 40, and 50 described in the first to fifth example embodiments are implemented as hardware. Therefore, effects similar to the effects described in any one of the first to fifth example embodiments can be obtained.

### Supplementary Notes

One aspect of the present invention is also described as the following supplementary notes, but is not limited to the following.

### Supplementary Note 1

An information providing device including:

acquisition means that acquires measurement data of a displacement amount of the earth's surface measured based on synthetic aperture radar (SAR) observation data, and acquires information indicating a feature of the earth's surface at a point where the displacement amount of the earth's surface is measured:

classification means that classifies the feature of the earth's surface at the point where the displacement amount of the earth's surface is measured based on the information indicating the feature of the earth's surface: and

display means that displays a symbol representing a classification of the feature of the earth's surface linked to the measurement data of the displacement amount of the earth's surface together with map data.

### Supplementary Note 2

The information providing device according to Supplementary Note 1, in which the acquisition means acquires information indicating a magnitude of relevance between time-series data of the displacement amount of the earth's surface and time-series data of a temperature at the point where the displacement amount of the earth's surface is measured.

### Supplementary Note 3

The information providing device according to Supplementary Note 1 or 2, in which the acquisition means acquires information indicating a magnitude of relevance between time-series observation data of the displacement amount of the earth's surface and time-series data of a precipitation amount at the point where the displacement amount of the earth's surface is measured.

### Supplementary Note 4

The information providing device according to any one of Supplementary Notes 1 to 3, in which the acquisition means acquires information indicating a difference between the measurement data of the displacement amount of the earth's surface and prediction data of the displacement amount of the earth's surface.

### Supplementary Note 5

The information providing device according to any one of

Supplementary Notes 1 to 4, in which the display means displays a symbol representing the feature of the earth's surface together with the map data.

### Supplementary Note 6

The information providing device according to any one of Supplementary Notes 1 to 5, further including condition selection means that causes a user to select one or more conditions associated to the feature of the earth's surface,

in which the display means displays a symbol representing the feature of the earth's surface associated to the selected condition together with the map data.

### Supplementary Note 7

The information providing device according to any one of Supplementary Notes 1 to 6, in which the display means displays multicolored map data indicating a magnitude of the difference between the measurement data of the displacement amount of the earth's surface and the prediction data of the displacement amount of the earth's surface.

### Supplementary Note 8

The information providing device according to Supplementary Note 7, in which

the display means displays option buttons for switching between a first screen on which the symbol and the map data are displayed and a second screen on which the multicolored map is displayed, and

the information providing device further includes screen switching means that performs switching between the first screen and the second screen based on an input operation on the option buttons.

### Supplementary Note 9

The information providing device according to any one of Supplementary Notes 1 to 8, further including measurement means that measures the displacement amount of the earth's surface based on the SAR observation data,

in which the acquisition means acquires the measurement data of the displacement amount of the earth's surface from the measurement means.

### Supplementary Note 10

An information providing method including:

acquiring measurement data of a displacement amount of an earth's surface measured based on SAR observation data, and acquiring information indicating a feature of the earth's surface at a point where the displacement amount of the earth's surface is measured:

classifying the feature of the earth's surface at the point where the displacement amount of the earth's surface is measured based on the information indicating the feature of the earth's surface: and

displaying a symbol representing a classification of the feature of the earth's surface linked to the measurement data of the displacement amount of the earth's surface together with map data.

### Supplementary Note 11

A program for causing a computer to execute:

acquiring measurement data of a displacement amount of an earth's surface measured based on SAR observation data, and acquiring information indicating a feature of the earth's surface at a point where the displacement amount of the earth's surface is measured:

classifying the feature of the earth's surface at the point where the displacement amount of the earth's surface is measured based on the information indicating the feature of the earth's surface; and

displaying a symbol representing a classification of the feature of the earth's surface linked to the measurement data of the displacement amount of the earth's surface together with map data.

### Supplementary Note 12

An observation system including:

the information providing device according to any one of Supplementary Notes 1 to 8:

a database that stores the SAR observation data:

a display that displays the symbol representing the classification of the feature of the earth's surface linked to the measurement data of the displacement amount of the earth's surface together with the map data.

While the present invention has been particularly shown and described with reference to example embodiments (and examples) thereof, the present invention is not limited to these example embodiments (and examples). It will be understood by those of ordinary skill in the art that various changes in form and details of the example embodiments (and examples) may be made therein without departing from the spirit and scope of the present invention as defined by the claims.

### INDUSTRIAL APPLICABILITY

The present invention can be used, for example, for research on geology and geography, and for providing information regarding geology and geography demanded by a civil engineering and construction industry and a real estate industry.

### REFERENCE SIGNS LIST

1 Observation system
10 Information providing device
11 Measurement unit
12 Acquisition unit
13 Classification unit
14 Display unit
20 Information providing device
30 Information providing device
35 Condition selection unit
30 Information providing device
45 Screen switching unit
50 Information providing device
100 Geospatial information server (database)
200 Monitor (display)

What is claimed is:

1. An information providing device comprising:
a memory configured to store instructions; and
at least one processor configured to execute the instructions to perform:
acquiring measurement data of a displacement amount of an earth's surface measured based on synthetic aperture radar (SAR) observation data, and acquire information indicating a feature of the earth's surface at a point where the displacement amount of the earth's surface is measured;
classifying the feature of the earth's surface at the point where the displacement amount of the earth's surface is measured based on the information indicating the feature of the earth's surface; and
displaying a symbol representing a classification of the feature of the earth's surface linked to the measurement data of the displacement amount of the earth's surface together with map data.

2. The information providing device according to claim 1, wherein
the at least one processor is configured to execute the instructions to perform:
acquiring information indicating a magnitude of relevance between time-series data of the displacement amount of the earth's surface and time-series data of a temperature at the point where the displacement amount of the earth's surface is measured.

3. The information providing device according to claim 1, wherein
the at least one processor is configured to execute the instructions to perform:
acquiring information indicating a magnitude of relevance between time-series observation data of the displacement amount of the earth's surface and time-series data of a precipitation amount at the point where the displacement amount of the earth's surface is measured.

4. The information providing device according to claim 13, wherein
the at least one processor is configured to execute the instructions to perform:
acquiring information indicating a difference between the measurement data of the displacement amount of the earth's surface and prediction data of the displacement amount of the earth's surface.

5. The information providing device according to claim 1, wherein
the at least one processor is configured to execute the instructions to perform:
displaying a symbol representing the feature of the earth's surface together with the map data.

6. The information providing device according to claim 1, wherein
the at least one processor is further configured to execute the instructions to perform:
causing a user to select one or more conditions associated to the feature of the earth's surface,
displaying a symbol representing the feature of the earth's surface associated to the selected condition together with the map data.

7. The information providing device according to claim 1, wherein
the at least one processor is further configured to execute the instructions to perform:
displaying multicolored map data indicating a magnitude of the difference between the measurement data of the displacement amount of the earth's surface and the prediction data of the displacement amount of the earth's surface.

8. The information providing device according to claim 7, wherein
the at least one processor is configured to execute the instructions to perform:
displaying option buttons for switching between a first screen on which the symbol and the map data are displayed and a second screen on which the multicolored map is displayed, and
the information providing device further comprises screen switching means configured to perform switching between the first screen and the second screen based on an input operation on the option buttons.

9. The information providing device according to claim 1, wherein
the at least one processor is further configured to execute the instructions to perform:
measuring the displacement amount of the earth's surface based on the SAR observation data,
acquiring the measurement data of the displacement amount of the earth's surface from the measurement means.

10. An information providing method comprising:
acquiring measurement data of a displacement amount of an earth's surface measured based on SAR observation data, and acquiring information indicating a feature of the earth's surface at a point where the displacement amount of the earth's surface is measured;
classifying the feature of the earth's surface at the point where the displacement amount of the earth's surface is measured based on the information indicating the feature of the earth's surface; and
displaying a symbol representing a classification of the feature of the earth's surface linked to the measurement data of the displacement amount of the earth's surface together with map data.

11. A non-transitory recording medium storing a program for causing a computer to perform:
acquiring measurement data of a displacement amount of an earth's surface measured based on SAR observation data, and acquiring information indicating a feature of the earth's surface at a point where the displacement amount of the earth's surface is measured;
classifying the feature of the earth's surface at the point where the displacement amount of the earth's surface is measured based on the information indicating the feature of the earth's surface; and
displaying a symbol representing a classification of the feature of the earth's surface linked to the measurement data of the displacement amount of the earth's surface together with map data.

12. (canceled)

13. The information providing method according to claim 10, wherein
the information providing method comprises:
acquiring information indicating a magnitude of relevance between time-series data of the displacement amount of the earth's surface and time-series data of a temperature at the point where the displacement amount of the earth's surface is measured.

14. The information providing method according to claim 10, wherein
the information providing method comprises:
acquiring information indicating a magnitude of relevance between time-series observation data of the displacement amount of the earth's surface and time-series data of a precipitation amount at the point where the displacement amount of the earth's surface is measured.

15. The information providing method according to claim 10, wherein
the information providing method comprises:
acquiring information indicating a difference between the measurement data of the displacement amount of the earth's surface and prediction data of the displacement amount of the earth's surface.

16. The information providing method according to claim 10, wherein
the information providing method comprises:
displaying a symbol representing the feature of the earth's surface together with the map data.

17. The non-transitory recording medium according to claim 11, wherein
the program causes the computer to perform:
acquiring information indicating a magnitude of relevance between time-series data of the displacement amount of the earth's surface and time-series data of a temperature at the point where the displacement amount of the earth's surface is measured.

18. The non-transitory recording medium according to claim 11, wherein
the program causes the computer to perform:
acquiring information indicating a magnitude of relevance between time-series observation data of the displacement amount of the earth's surface and time-series data of a precipitation amount at the point where the displacement amount of the earth's surface is measured.

19. The non-transitory recording medium according to claim 11, wherein
the program causes the computer to perform:
acquiring information indicating a difference between the measurement data of the displacement amount of the earth's surface and prediction data of the displacement amount of the earth's surface.

20. The non-transitory recording medium according to claim 11, wherein
the program causes the computer to perform:
displaying a symbol representing the feature of the earth's surface together with the map data.
